(19) United States
(12) Patent Application Publication
(10) Pub. No.: US 2010/0141047 A1
(43) Pub. Date: Jun. 10, 2010

(54) CLOSED TRANSITION AUTOMATIC TRANSFER SWITCH ASSEMBLY AND ASSOCIATED METHOD

(76) Inventors: Irving A. Gibbs, Mills River, NC (US); Justin Hoglund, Wake Forest, NC (US); Cathleen Clausen, Arden, NC (US); Robert Yanniello, Asheville, NC (US); Avadhoot Muley, Asheville, NC (US); Todd M. Lathrop, Oakdale, PA (US)

Correspondence Address: Martin J. Moran;Eaton Electrical, Inc., 1000 Cherrington Parkway, Moon Township, PA, 15108, US

(21) Appl. No.: 12/331,674

(22) Filed: Dec. 10, 2008

(51) Int. Cl. H02H 3/42

(52) U.S. Cl. 307/126

(57) ABSTRACT

The disclosed concept provides for a closed transition automatic transfer switch assembly having only two switch assemblies. This system utilizes a first switch assembly and a bypass switch assembly. The switch assemblies are each physically coupled to two power sources as well as the system load. The switch assemblies each include a power actuated contact arm. Each contact arm is coupled to, and in electrical communication with, the system load. Each contact arm may further be placed in one of the following configuration; a first configuration wherein the contact arm couples, and provides electrical communication between, the first source and the system load conductor, a second configuration wherein the contact arm couples, and provides electrical communication between, the second source and the system load conductor, and a neutral configuration wherein neither the first source nor the second source is coupled to, and in electrical communication with, the system load conductor.

### BACKGROUND OF THE INVENTION

1. Field of the Invention

This invention relates to a closed transition automatic transfer switch assembly and, more specifically, a closed transition automatic transfer switch assembly having only two switches.

2. Background Information

Certain installations, e.g. hospitals, (hereinafter “the system load”) must have power systems structured to provide an uninterruptable power supply. The primary power source is typically the public power grid and the secondary power source is typically a generator. Both of these sources are structured to provide power over an extended period of time. That is, the system typically draws power from the primary power source, however, if that source becomes disabled for an extended period of time, the secondary source is used. A third power supply, a continuous power supply (CPS), such as a fuel cell backup or battery backup is structured to maintain power to the system during short power interruptions, e.g. during an electrical storm. Because the system load cannot go without power, any transfer between energy sources must be a “closed transfer.” That is, before one energy source is disengaged from the system load, the other energy source must engage the system load so that there is no interruption in the supply of energy.

The primary and secondary power sources are typically mismatched in phase, voltage and frequency. As such, it is dangerous to have both the primary and secondary power sources coupled to the system load at the same time. However, as the system load cannot be without power, there is a necessity for a brief “transition overlap” wherein both power sources are coupled to, and in electrical communication with, the system load. The transition between power sources is typically accomplished by a closed transition automatic transfer switch assembly.

A closed transition automatic transfer switch assembly typically includes a first switch assembly, a second switch assembly, and a bypass switch assembly. All three switch assemblies are coupled to, and in electrical communication with the system load. Further, all three switch assemblies are structured to selectively engage one power source at a time. That is, the switch assemblies are coupled to both power sources, but only one power source at a time may pass energy through the switch assembly. The first and second switch assemblies are typically maintained in an enclosure. The first and second switch assemblies are removably disposed in the enclosure so that they may be removed for maintenance. The bypass switch assembly is fixed within the enclosure. Thus, the bypass switch assembly cannot be easily removed and maintenance thereon typically requires the system load (e.g. the hospital) to be powered down.

The first and second switch assemblies include an automatic, that is, power actuated, contact arm. The contact arm is coupled to, and in electrical communication with, the system load and is further structured to engage either the primary power source or the secondary power source, or, to be in a neutral position wherein neither power source is engaged. The power actuator moves the contact arm rapidly into engagement with the desired power source. The power actuator also allows for remote operation of the first and second switch assemblies. The bypass switch assembly includes a manually controlled contact arm. That is, the bypass contact arm cannot be actuated remotely.

During normal operation, one of the non-bypass switch assemblies provides for electrical communication between the primary power source and the system load. For the sake of this example, the first switch assembly will be said to be in use during normal operations. Further, during normal operation, the second switch assembly and the bypass switch assembly will be in the neutral position. If the system load needs to be powered by the secondary power source, the following operation occurs. First, the bypass switch assembly contact arm is moved to engage, that is, be in electrical communication with, the secondary power source. At this instant, both the primary and secondary power sources are coupled to the system load. As this may be dangerous, the first switch assembly is rapidly actuated so that the first switch assembly contact arm moves into the neutral position. Then, the second switch assembly contact arm is moved to engage the secondary power source as well. Finally, the bypass switch assembly is returned to the neutral position. A similar procedure is used to return to the primary power source.

During maintenance, the bypass switch assembly is used to supply energy to the system load. That is, rather than switching power sources, the bypass switch assembly engages the power source that is presently in use and the active switch assembly is moved into the neutral position so that it may be withdrawn from the enclosure.

### SUMMARY OF THE INVENTION

The disclosed concept provides for a closed transition automatic transfer switch assembly having only two switch assemblies. This system utilizes a first switch assembly and a bypass switch assembly. The switch assemblies are each physically coupled to two power sources as well as the system load. The switch assemblies each include a power actuated contactor. Each contactor is coupled to, and in electrical communication with, the system load. Each contactor may further be placed in one of the following configuration; a first configuration wherein the contactor couples, and provides electrical communication between, the first source and the system load conductor, a second configuration wherein the contactor couples, and provides electrical communication between, the second source and the system load conductor, and a neutral configuration wherein neither the first source nor the second source is coupled to, and in electrical communication with, the system load conductor.

The closed transition automatic transfer switch assembly operates as follows. The first switch assembly is in the first configuration, thus the system load is receiving energy from the first source. The bypass switch assembly is not in the second configuration, and is typically in the neutral configuration. The transfer is initiated by having the bypass switch assembly move into the second configuration. At this point in time the system load is coupled to both sources of energy. Accordingly, for the reasons stated above, the first switch assembly is rapidly moved out of the first configuration and, typically, moved into the neutral configuration. At this point in time, the system load is receiving energy only from the second source via the bypass switch assembly. Preferably, at this point the first switch assembly is also moved into the second configuration and the bypass switch assembly is moved into the neutral configuration. Thus, at the end of the transfer operation, the system load is receiving energy from the second source via the first switch assembly.

To switch back to the first energy source, the bypass switch assembly is moved into the first configuration. At this point in time the system load is coupled to both sources of energy. Accordingly, for the reasons stated above, the first switch assembly is rapidly moved out of the second configuration and, typically, moved into the neutral configuration. The first switch assembly is then moved into the first configuration and the bypass switch assembly is moved into the neutral configuration.

In an alternate procedure, the bypass switch assembly may be used to provide the system with energy from the second power source. That is, instead of moving the first switch assembly into the second configuration and utilizing the first switch assembly to power the system load, after the first switch assembly is disengaged from the first energy source, the first switch assembly is left in the neutral configuration. Further, the bypass switch assembly is maintained in the second configuration. To return to the first energy source, the first switch is moved into the first configuration. At this point in time the system load is coupled to both sources of energy. Accordingly, for the reasons stated above, the bypass switch assembly is rapidly moved out of the second configuration and, typically, moved into the neutral configuration. In this alternate procedure, the first switch assembly is always used to couple the system load to the first energy source and the bypass switch assembly is always used to couple the system load to the second energy source. This allows for reduced wear and tear on the first switch assembly second energy source conductor and reduced wear and tear on the bypass switch assembly first energy source conductor. Thus, after a period of time when the switch assemblies start to degrade, the switch assemblies may be swapped, or repurposed while in the original locations, so that the first switch assembly acts as the bypass switch assembly coupled to the second energy source and the bypass switch assembly acts as the first switch assembly coupled to the first energy source.

### BRIEF DESCRIPTION OF THE DRAWINGS

A full understanding of the invention can be gained from the following description of the preferred embodiments when read in conjunction with the accompanying drawings in which:

FIG. 1 is a schematic view of a power system having a system load, a first source of power, a second source of power and a transfer switch assembly.

FIG. 2 is an isometric view of a transfer switch assembly.

FIG. 3A-3E are schematic views of a transfer switch assembly with switches in various configurations. In FIG. 3A the first switch assembly is in the first configuration and the bypass switch assembly is in the neutral configuration. In FIG. 3B the first switch assembly is in the first configuration and the bypass switch assembly is in the second configuration. In FIG. 3C the first switch assembly is in the second configuration and the bypass switch assembly is in the second configuration. In FIG. 3D the first switch assembly is in the second configuration and the bypass switch assembly is in the neutral configuration. In alternate FIG. 3E the first switch assembly is in the neutral configuration and the bypass switch assembly is in the second configuration.

FIG. 4 is a flow chart of the method steps.

### DESCRIPTION OF THE PREFERRED EMBODIMENTS

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other.

As used herein and with reference to electrical components, “engage” shall mean temporarily coupled and allowing for electrical communication.

As used herein, a “power operated movable contact arm” is a contact arm structured to be moved by a motor or similar device. The motor may be remotely actuated, thus, the “power operated movable contact arm” may be remotely actuated.

As used herein, a “system load” is any load downstream of a transfer switch assembly but is, typically, a large installation such as, but not limited to, a building or manufacturing plant.

As used herein, a “transition overlap” is the time during which a system load is receiving energy from two separate sources.

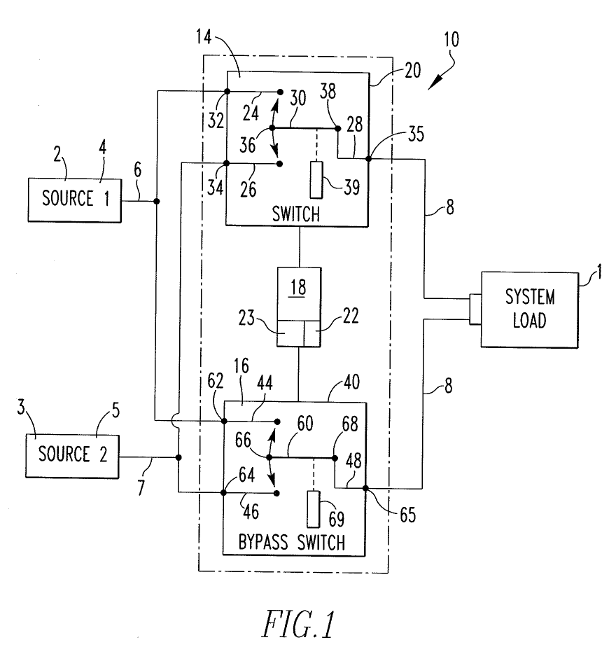

As shown schematically in FIG. 1, a system load 1 is structured to receive energy from two separate sources, a first source 2 and a second source 3. The energy sources 2, 3 may be, but not limited to, an electrical grid 4 and a generator 5. More specifically, electricity is provided by a first source conductor 6 and a second source conductor 7. Similarly, the system load 1 has a system load conductor 8. The source and load conductors 6, 7, 8 may be identified as “stabs.” Energy from the energy sources 2, 3 reaches the system load 1 via a closed transition automatic transfer switch assembly 10. The first source conductor 6, the second source conductor 7, and the system load conductor 8 are each structured to removably engage, that is, be in electrical communication with, a corresponding line/load conductor on the transfer switch assembly 10 as described below.

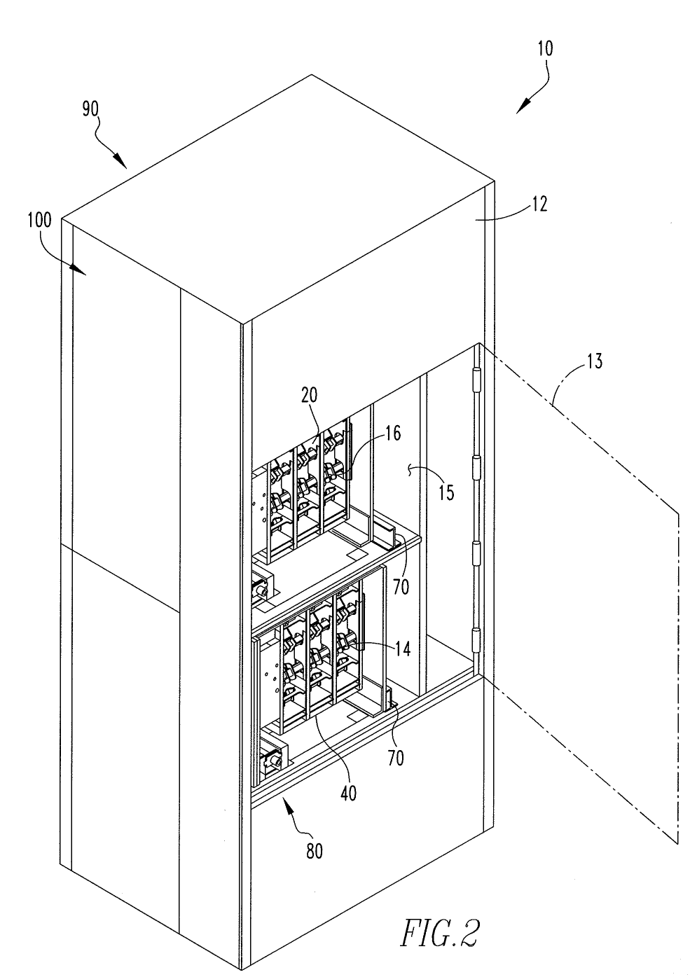

As shown in FIGS. 1 and 2, the transfer switch assembly 10 includes an enclosure 12, a first switch assembly 14, a bypass switch assembly 16, and a control system 18. The first switch assembly 14 and the bypass switch assembly 16 are substantially similar and the following description shall address a “switch assembly.” Two sets of reference numbers will follow the identified elements of the “switch assembly” wherein the first set of reference numbers belong to the first switch assembly 14 and the second set of reference numbers belong to the bypass switch assembly 16.

A switch assembly 14, 16 includes a housing 20, 40, a first line conductor 24, 44, a second line conductor 26, 46, one load conductor 28, 48, and a power operated, conductive, movable contact arm 30, 60. Each first line conductor 24, 44 includes an electrical coupling 32, 62 whereby each first line conductor 24, 44 is coupled to, and in electrical communication with, the first source 2 via the first source conductor 6. Each second line conductor 26, 46 includes an electrical coupling 34, 64 whereby each second line conductor 26, 46 is coupled to, and in electrical communication with, the second source 3 via the second source conductor 7. Each load conductor 28, 48 includes an electrical coupling 35, 65 whereby each is coupled to, and in electrical communication with, the system load 1 via the system load conductor 8. Each first line conductor 24, 44, second line conductor 26, 46 and load conductor 28, 48 extend into their respective switch assembly housings 20, 40.

Each power operated movable contact arm 30, 60 is also disposed within each switch assembly housing 20, 40. Each movable contact arm 30, 60 has a first end 36, 66 and a second end 38, 68. Each contact arm second end 38, 68 is coupled to, and in electrical communication with, their respective load conductor 28, 48. Each contact arm first end 36, 66 is structured to contact either a first line conductor 24, 44, a second line conductor 26, 46, or be in a neutral position as discussed below.

Each power operated movable contact arm 30, 60 is further coupled to an actuator 39, 69, such as, but not limited to, a motor. Each actuator 39, 69 is structured to move the associated contact arm 30, 60 between a first position and a second position, and having a neutral position therebetween. When a contact arm first end 36, 66 is in the first position the contact arm first end 36, 66 is coupled to, and in electrical communication with, the respective first line conductor 24, 44. When a contact arm first end 36, 66 is in the second position, the contact arm first end 36, 66 is coupled to, and in electrical communication with, the respective second line conductor 26, 46. When a contact arm first end 36, 66 is in the neutral position, the contact arm first end 36, 66 is not coupled to, and does not electrically communicate with, either the first or the second line conductor 24, 26, 44, 46.

Thus, each switch assembly 14, 16 is structured to have three configurations, a first configuration wherein the switch assembly 14, 16 couples, and provides electrical communication between, the first source conductor 6 and the system load conductor 8, a second configuration wherein the switch assembly 14, 16 couples, and provides electrical communication between, the second source conductor 7 and the system load conductor 8, and a neutral configuration wherein neither the first source conductor 6 nor the second source conductor 7 is coupled to, and in electrical communication with, the system load conductor 8.

The control system 18 is structured to control the switch assemblies 14, 16 and place each switch assembly 14, 16 in one of the identified configurations. It is noted that the configuration of the switch assemblies 14, 16 may be monitored by a sensor system described in U.S. patent application Ser. No. ______, Applicant's reference number 06-PCS-206 (130), filed contemporaneously herewith and incorporated by reference. The control system 18, preferably, includes a programmable logic circuit, i.e. a PLC or a computer chip (not shown), input/output devices (not shown), and may include a memory device (not shown). The control system 18 is structured to include a routine or other logic that determines, and may record, the configuration of the switch assemblies 14, 16. More specifically, the control system 18 is structured to actuate each switch assembly actuator 39, 69. That is, the control system 18 is electrically coupled to each switch assembly actuator 39, 69 and may send a signal to the switch assembly actuator 39, 69 which causes the switch assembly actuator 39, 69 to move the associated contact arm 30, 60 to one of the first position, second position, or neutral position. Preferably the switch assembly actuator 39, 69 is structured to move the associated contact arm 30, 60 between positions so that any transition overlap lasts, preferably, about 0.08 second but no more than about 0.1 second. Further, the control system 18 may be accessed remotely via a communications network (not shown) such as, but not limited to the Internet or a wireless communications system. Thus, each of the first switch assembly 14 and the bypass switch assembly 16 may be controlled remotely.

It is further noted that both the first switch assembly 14 and the bypass switch assembly 16 are removably disposed in the enclosure 12. Preferably, the first switch assembly 14 and the bypass switch assembly 16 are roll-out devices. That is, the enclosure 12 includes sets of rails (not shown) upon which each of the first switch assembly 14 and the bypass switch assembly 16 may be pulled out of the enclosure 12 for maintenance or other operations.

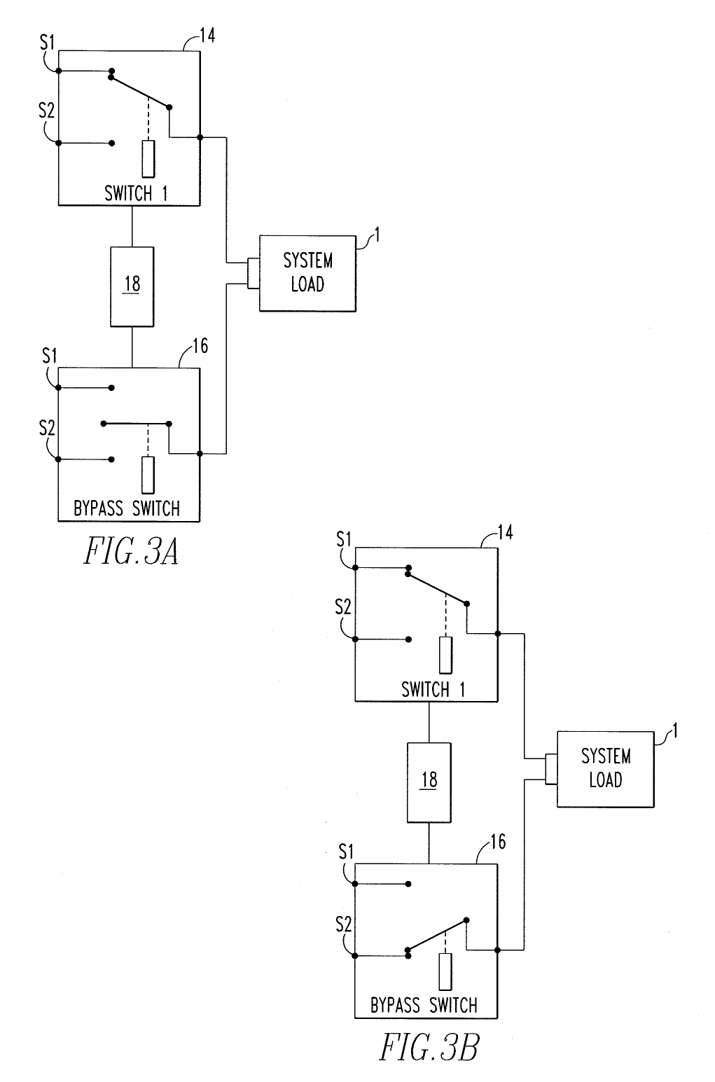

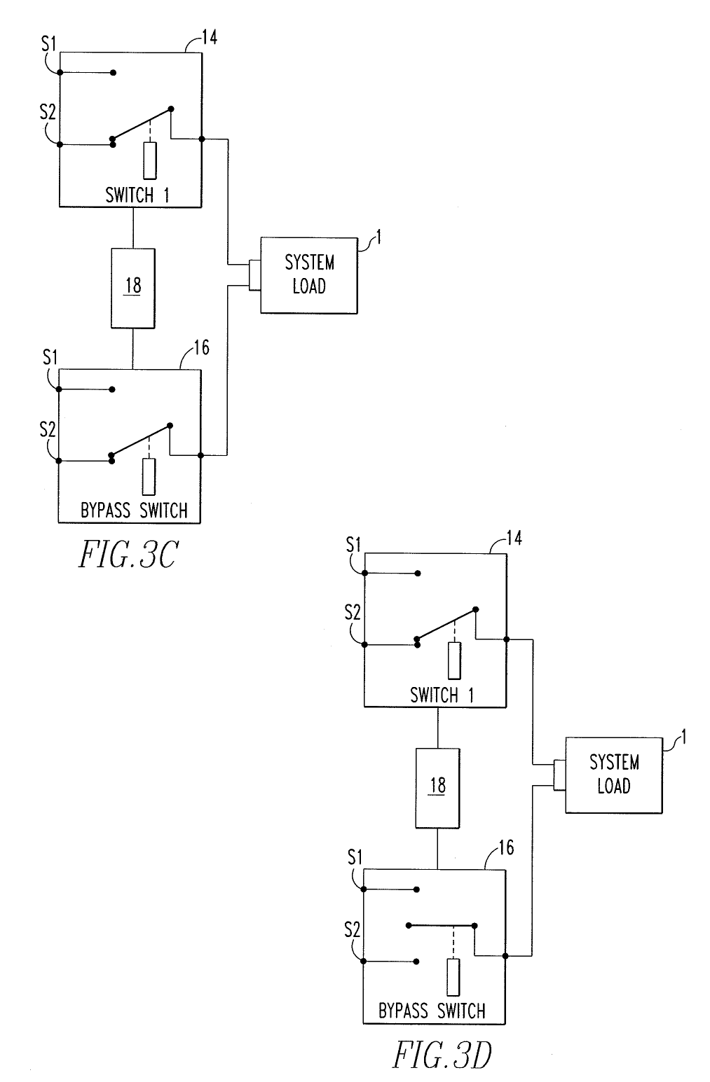

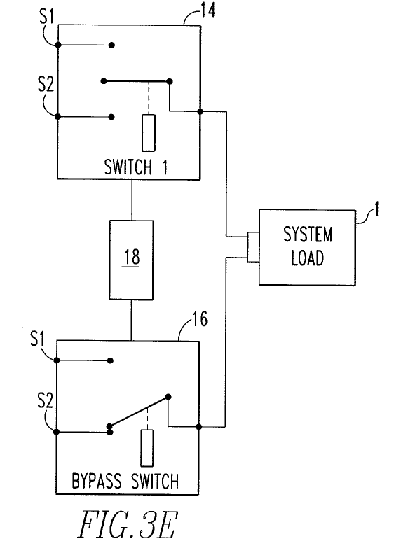

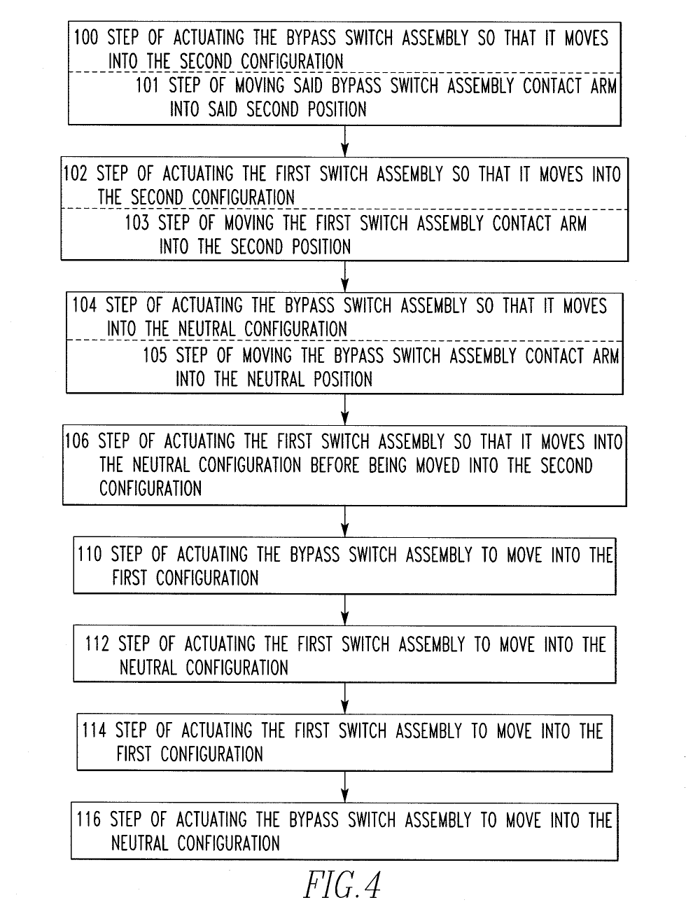

The transfer switch assembly 10 performs a closed transition as follows, and as shown schematically in FIGS. 3A-3E and the steps of the method are shown in FIG. 4. For the sake of this example, the system load 1 is coupled to, and in electrical communication with, the first energy source 2 via the first switch assembly 14. That is, the first switch assembly 14 is in the first configuration. While the bypass switch assembly 16 may be in the first configuration as well, it is preferable for the bypass switch assembly 16 to be in the neutral configuration during normal operation (FIG. 3A). That is, the bypass switch assembly 16 is not in the second configuration. To switch from the first energy source 2 to the second energy source 3, a user, who may be at a remote location, utilizes the control system 18 to perform the steps of actuating 100 the bypass switch assembly 16 so that it moves into the second configuration (FIG. 3B), actuating 102 the first switch assembly 14 so that it moves into the second configuration (FIG. 3C), and actuating 104 the bypass switch assembly 16 so that it moves into the neutral configuration (FIG. 3D). Once the first switch assembly 14 is in the second configuration and the bypass switch assembly 16 is in the neutral configuration, the system load 1 is receiving energy from the second energy source 3. Alternately, after the bypass switch assembly 16 is in the second configuration, the first switch assembly 14 may be actuated 106 so that it moves into the neutral configuration (FIG. 3E) before being moved into the second configuration (FIG. 3C).

As set forth above, the step of actuating 100 the bypass switch assembly 16 so that it moves into the second configuration includes the step of moving the bypass switch assembly contact arm 60 into the second position. Further, the step of actuating 102 the first switch assembly 14 so that it moves into the second configuration includes the step of moving 103 the first switch assembly contact arm 30 into the second position. Also, the step of actuating 104 the bypass switch assembly 16 so that it moves into the neutral configuration includes the step of moving 105 the bypass switch assembly contact arm 60 into the neutral position.

It is noted that, at the point wherein the first switch assembly 14 is in the first configuration and the bypass switch assembly 16 is in the second configuration, the system load 1 is coupled to two energy sources. As noted above this may be dangerous, therefore the step of actuating 102 the first switch assembly 14 so that it moves into the second configuration, or actuating 106 the first switch assembly 14 so that it moves into the neutral configuration, is preferably performed rapidly, e.g. within about 0.1 seconds, after the bypass switch assembly 16 is in the second configuration.

The user may return the transfer switch assembly 10 to the original configuration by performing the additional steps of actuating 110 the bypass switch assembly 16 to move into the first configuration, actuating 112 the first switch assembly to move into the neutral configuration, actuating 114 the first switch assembly to move into the first configuration, and actuating 116 the bypass switch assembly to move into the neutral configuration. As detailed above, it is understood that for each step of moving a switch assembly 14, 16 into a new configuration, there is a corresponding step of moving a contact arm 30, 60 into the corresponding position for the associated switch assembly 14, 16. Further, and as before, any time the system load 1 is coupled to, and in electrical communication with, two sources of energy, one of the sources is decoupled rapidly.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A closed transition automatic transfer switch assembly structured to provide energy to a system load via a system load conductor and structured to receive energy from a first and a second source via conductors, a first source conductor and a second source conductor, said closed transition automatic transfer switch assembly comprising:
a first switch assembly coupled to, and in electrical communication with, each of said first source conductor, said second source conductor, and said system load conductor, said first switch assembly structured to have three configurations, a first configuration wherein said first switch assembly couples, and provides electrical communication between, said first source conductor and said system load conductor, a second configuration wherein said first switch assembly couples, and provides electrical communication between, said second source conductor and said system load conductor, and a neutral configuration wherein neither said first source conductor nor said second source conductor is coupled to, and in electrical communication with, said system load conductor via said first switch assembly;
a bypass switch assembly coupled to, and in electrical communication with, each of said first source conductor, said second source conductor, and said system load conductor, said bypass switch assembly structured to have three configurations, a first configuration wherein said bypass switch assembly couples, and provides electrical communication between, said first source conductor and said system load conductor, a second configuration wherein said bypass switch assembly couples, and provides electrical communication between, said second source conductor and said system load conductor, and a neutral configuration wherein neither said first source conductor nor said second source conductor is coupled to, and in electrical communication with, said system load conductor via said bypass switch assembly;
a control system structured to control a plurality of switch assemblies, said control system coupled to said first switch assembly and said bypass switch assembly and structured to place each said first switch assembly and said bypass switch assembly in one of said first, second, or neutral configurations; and
wherein, when said first switch assembly is in said first configuration and said bypass switch assembly is not in said second configuration, said control system is further structured to perform a closed transition from said first source to said second source by actuating said bypass switch assembly to move into said second configuration, actuating said first switch assembly to move into said second configuration, and actuating said bypass switch assembly to move into said neutral configuration.

2. The closed transition automatic transfer switch assembly of claim 1 wherein said control system is structured to allow a transition overlap of no more than about 0.1 second.

3. The closed transition automatic transfer switch assembly of claim 2 wherein said control system is structured to allow a transition overlap of about 0.08 second.

4. The closed transition automatic transfer switch assembly of claim 1 wherein said first switch assembly and said bypass switch assembly each must pass through said neutral configuration when moving between said first configuration and said second configuration.

5. The closed transition automatic transfer switch assembly of claim 1 wherein:
said first switch assembly is structured to be removably disposed within an enclosure; and
said bypass switch assembly is structured to be removably disposed within an enclosure.

6. The closed transition automatic transfer switch assembly of claim 1 wherein:
said first switch assembly has two line side conductors, a first line conductor and a second line conductor, and one load conductor, said first switch assembly first line conductor structured to be coupled to, and in electrical communication with, said first source conductor, said first switch assembly second line conductor structured to be coupled to, and in electrical communication with, said second source conductor, and said first switch assembly load conductor structured to be coupled to, and in electrical communication with, said system load conductor; and
said bypass switch assembly has two line side conductors, a first line conductor and a second line conductor, and one load conductor, said bypass switch assembly first line conductor structured to be coupled to, and in electrical communication with, said first source conductor, said bypass switch assembly second line conductor structured to be coupled to, and in electrical communication with, said second source conductor, and said bypass switch assembly load conductor structured to be coupled to, and in electrical communication with, said system load conductor.

7. The closed transition automatic transfer switch assembly of claim 6 wherein:
said first switch assembly includes a power operated movable contact arm having a first end and a second end;
said first switch assembly contact arm second end coupled to, and in electrical communication with, said first switch assembly load conductor;
said first switch assembly contact arm first end structured to move between a first position and a second position and having a neutral position therebetween, wherein when said first switch assembly contact arm first end is in said first position said first switch assembly contact arm first end is coupled to, and in electrical communication with, said first switch assembly first line conductor and a second position, wherein when said first switch assembly contact arm first end is in said second position said first switch assembly contact arm first end is coupled to, and in electrical communication with, said first switch assembly second line conductor, and wherein when said first switch assembly contact arm first end is in said neutral position said first switch assembly contact arm first end is not coupled to, and does not electrically communicate with, either first switch assembly line conductors;
said bypass switch assembly includes a power operated movable contact arm having a first end and a second end;
said bypass switch assembly contact arm second end coupled to, and in electrical communication with, said bypass switch assembly load conductor; and
said bypass switch assembly contact arm first end structured to move between a first position and a second position and having a neutral position therebetween, wherein when said bypass switch assembly contact arm first end is in said first position said first switch assembly contact arm first end is coupled to, and in electrical communication with, said bypass switch assembly first line conductor and a second position, wherein when said bypass switch assembly contact arm first end is in said second position said bypass switch assembly contact arm first end is coupled to, and in electrical communication with, said bypass switch assembly second line conductor, and wherein when said bypass switch assembly contact arm first end is in said neutral position said bypass switch assembly contact arm first end is not coupled to, and does not electrically communicate with, either bypass switch assembly line conductors.

8. The closed transition automatic transfer switch assembly of claim 7 wherein said control system is structured to allow a transition overlap of no more than about 0.1 second.

9. The closed transition automatic transfer switch assembly of claim 8 wherein said control system is structured to allow a transition overlap of about 0.08 second.

10. A method of performing a closed transfer between two energy sources utilizing a closed transition automatic transfer switch assembly wherein energy is provided from a first energy source via a first source conductor, energy is provided from a second energy source via a second source conductor, energy is provided to a system load via a system load conductor, said automatic transfer switch assembly includes a first switch assembly coupled to, and in electrical communication with, each of said first source conductor, said second source conductor, and said system load conductor, said first switch assembly structured to have three configurations, a first configuration wherein said first switch assembly couples, and provides electrical communication between, said first source conductor and said system load conductor, a second configuration wherein said first switch assembly couples, and provides electrical communication between, said second source conductor and said system load conductor, and a neutral configuration wherein neither said first source conductor nor said second source conductor is coupled to, and in electrical communication with, said system load conductor via said first switch assembly, and a bypass switch assembly coupled to, and in electrical communication with, each of said first source conductor, said second source conductor, and said system load conductor, said bypass switch assembly structured to have three configurations, a first configuration wherein said bypass switch assembly couples, and provides electrical communication between, said first source conductor and said system load conductor, a second configuration wherein said bypass switch assembly couples, and provides electrical communication between, said second source conductor and said system load conductor, and a neutral configuration wherein neither said first source conductor nor said second source conductor is coupled to, and in electrical communication with, said system load conductor via said bypass switch assembly, as well as a control system structured to control a plurality of switch assemblies, said control system coupled to said first switch assembly and said bypass switch assembly and structured to place each said first switch assembly and said bypass switch assembly in one of said first, second, or neutral configurations, said method comprising the steps of:
actuating said bypass switch assembly to move into said second configuration;
actuating said first switch assembly to move into said second configuration; and
actuating said bypass switch assembly to move into said neutral configuration.

11. The method of claim 10 wherein said closed transition automatic transfer switch assembly is returned to the original configuration by performing the further steps of:
actuating said bypass switch assembly to move into said first configuration;
actuating said first switch assembly to move into said neutral configuration;
actuating said first switch assembly to move into said first configuration; and
actuating said bypass switch assembly to move into said neutral configuration.

12. The method of claim 10 wherein said first switch assembly has two line side conductors, a first line conductor and a second line conductor, and one load side conductor, said first switch assembly first line conductor structured to be, and is, coupled to, and in electrical communication with, said first source conductor, said first switch assembly second line conductor structured to be, and is, coupled to, and in electrical communication with, said second source conductor, and said first switch assembly load conductor structured to be, and is, coupled to, and in electrical communication with, said system load conductor, said first switch assembly further includes a power operated movable contact arm having a first end and a second end, said first switch assembly contact arm second end coupled to, and in electrical communication with, said first switch assembly load conductor, said first switch assembly contact arm first end structured to move between a first position and a second position and having a neutral position therebetween, wherein when said first switch assembly contact arm first end is in said first position said first switch assembly contact arm first end is coupled to, and in electrical communication with, said first switch assembly first line conductor and a second position, wherein when said first switch assembly contact arm first end is in said second position said first switch assembly contact arm first end is coupled to, and in electrical communication with, said first switch assembly second line conductor, and wherein when said first switch assembly contact arm first end is in said neutral position said first switch assembly contact arm first end is not coupled to, and does not electrically communicate with, either first switch assembly line conductors, and wherein said bypass switch assembly has two line side conductors, a first line conductor and a second line conductor, and one load side conductor, said bypass switch assembly first line conductor structured to be, and is, coupled to, and in electrical communication with, said first source conductor, said bypass switch assembly second line conductor structured to be, and is, coupled to, and in electrical communication with, said second source conductor, and said bypass switch assembly load conductor structured to be, and is, coupled to, and in electrical communication with, said system load conductor, said bypass switch assembly further includes a power operated movable contact arm having a first end and a second end, said bypass switch assembly contact arm second end coupled to, and in electrical communication with, said bypass switch assembly load conductor, said bypass switch assembly contact arm first end structured to move between a first position and a second position and having a neutral position therebetween, wherein when said bypass switch assembly contact arm first end is in said first position said first switch assembly contact arm first end is coupled to, and in electrical communication with, said bypass switch assembly first line conductor and a second position, wherein when said bypass switch assembly contact arm first end is in said second position said bypass switch assembly contact arm first end is coupled to, and in electrical communication with, said bypass switch assembly second line conductor, and wherein when said bypass switch assembly contact arm first end is in said neutral position said bypass switch assembly contact arm first end is not coupled to, and does not electrically communicate with, either bypass switch assembly line conductors, and wherein:
said step of actuating said bypass switch assembly to move into said second configuration includes the step of moving said bypass switch assembly contact arm into said second position;
said step of actuating said first switch assembly to move into said second configuration includes the step of moving said first switch assembly contact arm into said second position; and
said step of actuating said bypass switch assembly to move into said neutral configuration includes the step of moving said bypass switch assembly contact arm into said neutral position.

13. The method of claim 12 wherein said steps of moving said bypass switch assembly contact arm into said second position, moving said first switch assembly contact arm into said second position, and moving said bypass switch assembly contact arm into said neutral position are each accomplished remotely.

14. The method of claim 12 wherein said steps of moving said bypass switch assembly contact arm into said second position, moving said first switch assembly contact arm into said second position, and moving said bypass switch assembly contact arm into said neutral position are each accomplished with a transition overlap of no more than about 0.1 second.

15. The method of claim 14 wherein said steps of moving said bypass switch assembly contact arm into said second position, moving said first switch assembly contact arm into said second position, and moving said bypass switch assembly contact arm into said neutral position are each accomplished with a transition overlap of about 0.08 second.

16. A method of performing a closed transfer between two energy sources utilizing a closed transition automatic transfer switch assembly wherein energy is provided from a first energy source via a first source conductor, energy is provided from a second energy source via a second source conductor, energy is provided to a system load via a system load conductor, said automatic transfer switch assembly includes a first switch assembly coupled to, and in electrical communication with, each of said first source conductor, said second source conductor, and said system load conductor, said first switch assembly structured to have three configurations, a first configuration wherein said first switch assembly couples, and provides electrical communication between, said first source conductor and said system load conductor, a second configuration wherein said first switch assembly couples, and provides electrical communication between, said second source conductor and said system load conductor, and a neutral configuration wherein neither said first source conductor nor said second source conductor is coupled to, and in electrical communication with, said system load conductor, and a bypass switch assembly coupled to, and in electrical communication with, each of said first source conductor, said second source conductor, and said system load conductor, said bypass switch assembly structured to have three configurations, a first configuration wherein said bypass switch assembly couples, and provides electrical communication between, said first source conductor and said system load conductor, a second configuration wherein said bypass switch assembly couples, and provides electrical communication between, said second source conductor and said system load conductor, and a neutral configuration wherein neither said first source conductor nor said second source conductor is coupled to, and in electrical communication with, said system load conductor, as well as a control system structured to control a plurality of switch assemblies, said control system coupled to said first switch assembly and said bypass switch assembly and structured to place each said first switch assembly and said bypass switch assembly in one of said first, second, or neutral configurations, said method comprising the steps of:
actuating said bypass switch assembly to move into said second configuration; and
actuating said first switch assembly to move into said neutral configuration.

17. The method of claim 16 wherein said closed transition automatic transfer switch assembly is returned to the original configuration by performing the further steps of:
actuating said first switch assembly to move into said first configuration; and
actuating said bypass switch assembly to move into said neutral configuration.

18. The method of claim 17 wherein said first switch assembly has two line side conductors, a first line conductor and a second line conductor, and one load side conductor, said first switch assembly first line conductor structured to be, and is, coupled to, and in electrical communication with, said first source conductor, said first switch assembly second line conductor structured to be, and is, coupled to, and in electrical communication with, said second source conductor, and said first switch assembly load conductor structured to be, and is, coupled to, and in electrical communication with, said system load conductor, said first switch assembly further includes a power operated movable contact arm having a first end and a second end, said first switch assembly contact arm second end coupled to, and in electrical communication with, said first switch assembly load conductor, said first switch assembly contact arm first end structured to move between a first position and a second position and having a neutral position therebetween, wherein when said first switch assembly contact arm first end is in said first position said first switch assembly contact arm first end is coupled to, and in electrical communication with, said first switch assembly first line conductor and a second position, wherein when said first switch assembly contact arm first end is in said second position said first switch assembly contact arm first end is coupled to, and in electrical communication with, said first switch assembly second line conductor, and wherein when said first switch assembly contact arm first end is in said neutral position said first switch assembly contact arm first end is not coupled to, and does not electrically communicate with, either first switch assembly line conductors, and wherein said bypass switch assembly has two line side conductors, a first line conductor and a second line conductor, and one load side conductor, said bypass switch assembly first line conductor structured to be, and is, coupled to, and in electrical communication with, said first source conductor, said bypass switch assembly second line conductor structured to be, and is, coupled to, and in electrical communication with, said second source conductor, and said bypass switch assembly load conductor structured to be, and is, coupled to, and in electrical communication with, said system load conductor, said bypass switch assembly further includes a power operated movable contact arm having a first end and a second end, said bypass switch assembly contact arm second end coupled to, and in electrical communication with, said bypass switch assembly load conductor, said bypass switch assembly contact arm first end structured to move between a first position and a second position and having a neutral position therebetween, wherein when said bypass switch assembly contact arm first end is in said first position said first switch assembly contact arm first end is coupled to, and in electrical communication with, said bypass switch assembly first line conductor and a second position, wherein when said bypass switch assembly contact arm first end is in said second position said bypass switch assembly contact arm first end is coupled to, and in electrical communication with, said bypass switch assembly second line conductor, and wherein when said bypass switch assembly contact arm first end is in said neutral position said bypass switch assembly contact arm first end is not coupled to, and does not electrically communicate with, either bypass switch assembly line conductors, and wherein:
said step of actuating said bypass switch assembly to move into said second configuration includes the step of moving said bypass switch assembly contact arm into said second position; and
said step of actuating said first switch assembly to move into said neutral configuration includes the step of moving said first switch assembly contact arm into said neutral position.

19. The method of claim 18 wherein said steps of moving said bypass switch assembly contact arm into said second position, moving said first switch assembly contact arm into said second position, and moving said bypass switch assembly contact arm into said neutral position are each accomplished remotely.

20. The closed transition automatic transfer switch assembly of claim 16 wherein said control system is structured to allow a transition overlap of about 0.1 second.
